(19) United States
(12) Patent Application Publication
(10) Pub. No.: US 2014/0083672 A1
(43) Pub. Date: Mar. 27, 2014

(54) Automatic Recirculation Control for Vehicular HVAC System

(71) Applicant: FORD GLOBAL TECHNOLOGIES, LLC, DEARBORN, MI (US)

(72) Inventors: James C. Rollinson, Superior Township, MI (US); Alan D. Wallington, Detroit, MI (US)

(73) Assignee: FORD GLOBAL TECHNOLOGIES, LLC, DEARBORN, MI (US)

(21) Appl. No.: 13/625,199

(22) Filed: Sep. 24, 2012

(51) Int. Cl. B60H 1/00; F25D 17/04; B60L 1/02; B60H 1/32; B60H 1/26

(52) U.S. Cl. 165/202; 454/139; 454/156; 219/203; 62/176.2

(57) ABSTRACT

Recirculation of air within a passenger cabin by a vehicular HVAC system is controlled to maximize the use of recirculation without causing discomfort from a large air flow around the legs of a passenger located near the cabin air return vent. An automatic recirculation condition is detected in response to first conditions including a window defrost setting. A fogging probability is determined in response to second conditions including a humidity measurement. Occupancy of a passenger seat adjacent the cabin air return vent is detected. A partial recirculation of the return vent is set in response to the fogging probability and the detected occupancy.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to regulating incoming air flow in a vehicular heating, ventilating, and air conditioning (HVAC) system. More specifically, the invention relates to a system and method for providing an efficient selection between 100% fresh air mode and 100% recirculated air mode to optimize heating/cooling performance while increasing fuel economy in the case of an internal combustion (IC) vehicle, increasing IC engine off time in the case of a hybrid vehicle, and reducing battery power consumption in the case of an electric vehicle (EV).

Improved fuel economy for IC engine-powered vehicles has long been a goal of automobile manufacturers. The advent of electric vehicles (EV) and hybrid electric vehicles (HEV) has resulted in a new goal of maximizing efficiency of the use of battery power (thereby reducing IC engine on time in the case of the HEV). One of the challenges to achievement of these goals is the need to maintain a comfortable climate in the passenger cabin.

Cabin comfort is maintained by both vehicle heating and cooling systems. When heating and cooling systems were first introduced, incoming fresh air was relied upon for both heating and cooling. As systems developed, a recirculation mode was introduced in which cabin air is recycled through the HVAC system since it will already have a temperature closer to the desired temperature than the outside air. Besides full recirculation, a partial recirculation mode may also be used in which an inlet mechanism adjusts a proportion of fresh air to recirculated air that is inlet to the HVAC system via the HVAC blower.

A system and method for a partial air inlet control strategy is disclosed in U.S. Patent Application Publication 2012/0009859A1, which is incorporated herein by reference. It discloses that if the air entering the HVAC is not managed carefully, fuel economy and battery consumption may not be optimized. Particularly, if the fresh air mode is selected as the source of air for the HVAC system in hot weather, this air mode will add more cooling load to the compressor and increase energy consumption. On the other hand, if the fresh air mode is selected as the source of air for the HVAC system in cold weather, this air mode will slow down heater/defrost performance. A further complication is that when the full recirculation mode is selected, window fogging may result in certain ambient conditions. Thus, a partial recirculation control strategy is disclosed in which the air inlet door is controlled to move progressively to partial recirculation positions by taking into account the cooling/heating loads and the probability of fogging. As cooling/heating loads increase, the air inlet door moves toward a 100% recirculation mode. As fogging probability increases, the air inlet door moves toward a 100% fresh air mode. By selectively choosing a position between 100% recirculation and 100% fresh air, fuel economy and/or battery power consumption are optimized without compromising passenger comfort or causing fogging on interior glass surfaces.

For any particular vehicle model, target values for a partial recirculation setting according to different vehicle conditions are determined by performing calibration procedures during the vehicle design process by the vehicle manufacturer. The appropriate amount of partial recirculation for any particular temperature/humidity conditions may vary as a function of the speed of the HVAC blower and the velocity of the vehicle because these parameters affect the speed of fresh and recirculated air flows (e.g., at high velocity there may be a tendency for a ram air effect to cause fresh air to reverse its flow direction through the cabin air return vent). Another factor to be considered in calibrating the partial recirculation settings relates to any secondary physical effects of the modified air flow patterns on the passengers within the vehicle. For instance, the cabin air return vent is typically located near the floor in front of the front seat passenger location. When a passenger is seated in this location, the air being recirculated flows around their legs as it returns to the air return vent. As the recirculating air flow increases, the passenger may notice a cooling effect on their legs which may become uncomfortable. Therefore, the calibration process may require a lower amount of recirculated air under certain conditions and what could be achieved without this issue. Consequently, some of the potential increases in energy efficiencies may not be achieved.

### SUMMARY OF THE INVENTION

In one aspect of the invention, a method is provided for controlling recirculation of a vehicular HVAC system. An automatic recirculation condition is detected in response to first conditions including a window defrost setting. A fogging probability is determined in response to second conditions including a humidity measurement. Occupancy of a passenger seat adjacent a cabin air return vent is detected. A partial recirculation of the return vent is set in response to the fogging probability and the detected occupancy.

### BRIEF DESCRIPTION OF THE DRAWINGS

FIG. 1 is a schematic view of an HVAC air handling system capable of partial recirculation settings.

FIG. 2 is a perspective and schematic view of a vehicle apparatus according to the present invention.

FIG. 3 is a flowchart showing one preferred embodiment of the invention.

FIG. 4 shows lookup tables for a partial recirculation base value.

FIG. 5 shows lookup tables for a partial recirculation increment.

### DETAILED DESCRIPTION OF PREFERRED EMBODIMENTS

FIG. 1 shows schematically an air handling system of a heating, ventilation and air conditioning (HVAC) system 10. A blower 11 driven by a blower motor 12 receives inlet air comprised of fresh air from a duct 13 and/or recirculated air from a cabin air return vent 14 as determined by a recirculation door 15. System 10 also includes a panel-defrost door 16, a floor-panel door 17, and a temperature blend door 18. Door 15 functions to regulate air passing to the inlet of blower 11 between fresh air and recirculated air. As used herein, a partial recirculation setting may be expressed as a percentage opening of door 15 (i.e. the proportional share of inlet air that is being recirculated). Thus, a higher percentage indicates a greater amount of recirculated air. Other known air flow regulating devices may be used instead of the illustrated door configuration.

The various doors are driven by any of several types of actuators (including, for example and without limitation, electric motors and vacuum controllers) in a conventional fashion. Door 15 may be preferably driven by an electric servomotor so that the position of door 15 is continuously variable.

System 10 further includes heating and cooling elements such as a heater core 20 (receiving a flow of coolant heated by an IC engine or a supplemental heat source) and an evaporator core 21 (receiving a flow of refrigerant from an air conditioning system 22). The evaporator temperature is normally controlled in a conventional automatic fashion to allow the system to dehumidify air passing thereover. System 22 includes a compressor, a condenser, a refrigerant tank, a pressure cycling switch, and an expansion device for metering refrigerant to evaporator core 21. Various ducts couple a heated/cooled air flow from HVAC 10 to various outlets and registers including panel, defrost, and demister registers as known in the art.

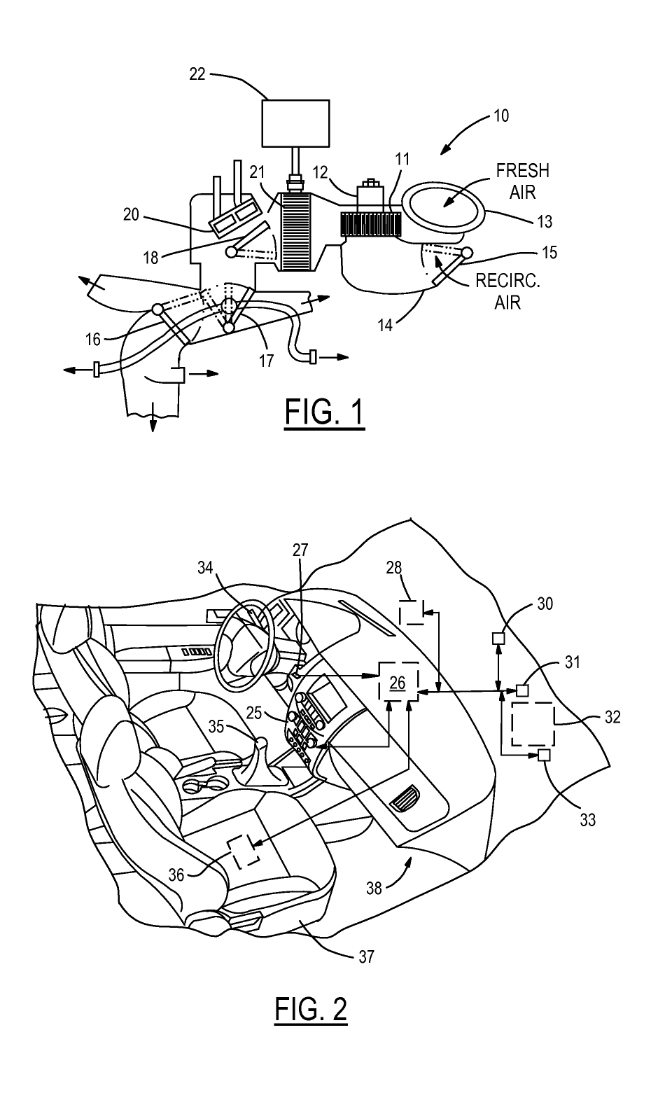

For automatic control of the temperature and flow of air in the cabin, certain conditions inside and outside the cabin are monitored by sensors, some of which are shown in FIG. 2. An instrument-panel mounted HVAC control panel 25 generates user demand signals that are coupled to an HVAC controller 26 which sends appropriate command signals to control various actuators in the vehicle including the HVAC doors, the air conditioning system, the blower motor, electric window heaters, and the like. Controller 26 is coupled to sensors (either directly or through a multiplex communication bus) including an in-car temperature and humidity sensor 27 (which is typically located in the instrument panel but can be located elsewhere in the vehicle's interior). It is to be understood that temperature and humidity (or dewpoint) sensing may be done in a single sensor 27 or may be done by individual temperature and humidity sensors as is known in the art. Other sensors include a windshield glass temperature sensor 28, an ambient (outside) air temperature (OAT) sensor 30 (which is typically located in the front of the vehicle forward of the grill or elsewhere, such as associated with the vehicle's mirror, bumper or roof), and an engine coolant temperature (ECT) sensor 31 (associated with an IC engine 32). A powertrain control module 33 associated with engine 32 provides other data signals such as a vehicle speed (velocity) to controller 26. In addition, a temperature demand signal (Tₛₑₜ) indicating a desired temperature and a blower speed setting are set manually by users via control panel 25, and these settings are sent to controller 26. Other user control actions, such as turning on the windshield wipers using a stalk switch 34 or activating an electric window heater using control panel 25 are also communicated to controller 26 which uses all this data to regulate operation of the HVAC system.

A seat occupancy sensor 35 is associated with a passenger seat 36. An occupant seating in seat 36 places their legs in a leg region 37 which is adjacent to the cabin air return vent (not shown). Sensor 35 may be comprised of a weight sensor or maybe a component of a passenger restraint system such as a seat belt sensor, for example. A transmission gear selector 35 includes an electronic switch for providing a transmission gear setting to controller 36.

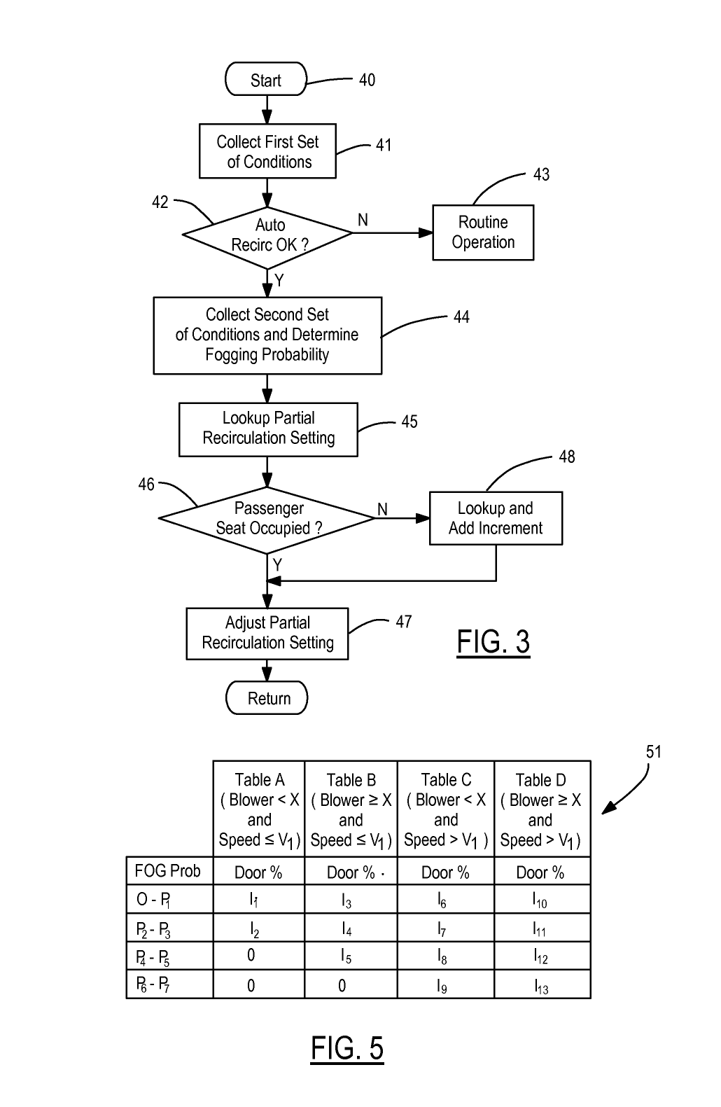

A preferred method of the invention is shown in FIG. 3, wherein an HVAC system initially operates in a conventional manner in step 40. During subsequent operation of the vehicle, a first set of variable conditions are collected in step 41 in order to determine whether an automatic recirculation condition exists. Conditions in which automatic control of a partial recirculation setting would not appropriate include 1) times when a manual user command input is requesting a defrost mode, 2) the vehicle transmission gear being in park or the vehicle speed being below a low threshold speed and the outside ambient temperature being less than a predetermined temperature because these may indicate that the vehicle has just been started and fogging probability may be high, or 3) engine coolant temperature is below a predetermined temperature or a glass control action has been initiated by the driver such as turning on a heated windshield or turning on windshield wipers which may indicate a cold vehicle or an attempt to clear the windshield. Thus, one of the variable conditions in the first set is comprised of a window defrost setting. Step 42 checks whether an automatically recirculation control action is appropriate (e.g., the window defrost setting is not on), and if not then routine HVAC operation continues to be performed in step 43.

If conditions exist in which automatic recirculation control is appropriate, then a second set of conditions are collected in step 44 and a fogging probability is determined based on those conditions. In particular, the second set of conditions preferably includes a humidity measurement, an outside air temperature measurement, and an in-cabin temperature measurement. Since it has already been determined that automatic control of partial recirculation is appropriate, a partial recirculation setting can potentially be increased depending on the probability of fogging. Fogging probability is dependent upon the relative humidity and inside and outside temperature measurements according to known relationships. Either a look up table or a calculation can be performed to provide a value of the fogging probability as described in U.S. Patent Application Publication 2012/0009859A1.

In step 45, a partial recirculation setting is obtained from a look up table based on the fogging probability and other conditions. As shown in FIG. 4, the plurality of look up tables 50 may be organized according to different vehicle speed ranges and different blower speed ranges as also described in US Patent Application Publication 2012/0009859A1. Within each table, a range of fogging probabilities is correlated to respective partial recirculation door settings S_{a,b}, each having a value that is determined by a calibration process during development of each vehicle model's design. Conventionally, the values of S_{a,b} have been determined to ensure that at any particular temperature conditions (together with air flow rates corresponding to current blower motor settings and vehicle speed) do not result in an excessive airflow around a passenger's legs that would create an undesired cooling effect on the legs.

According to the present invention, the calibrated values in the tables shown in FIG. 4 are modified as appropriate whenever a passenger is not located in the seat adjacent to the cabin air return vent since under those conditions there is no need to avoid passenger discomfort. Returning to FIG. 3, after looking up a partial recirculation setting in step 45, a check is made in step 46 to determine whether the passenger seat is occupied. If occupied, then the partial recirculation setting is adjusted using a base calibrated value in step 47. If the passenger seat is not occupied, then a partial recirculation increment is looked up and added to the base value in step 48 before the partial recirculation setting is adjusted in step 47.

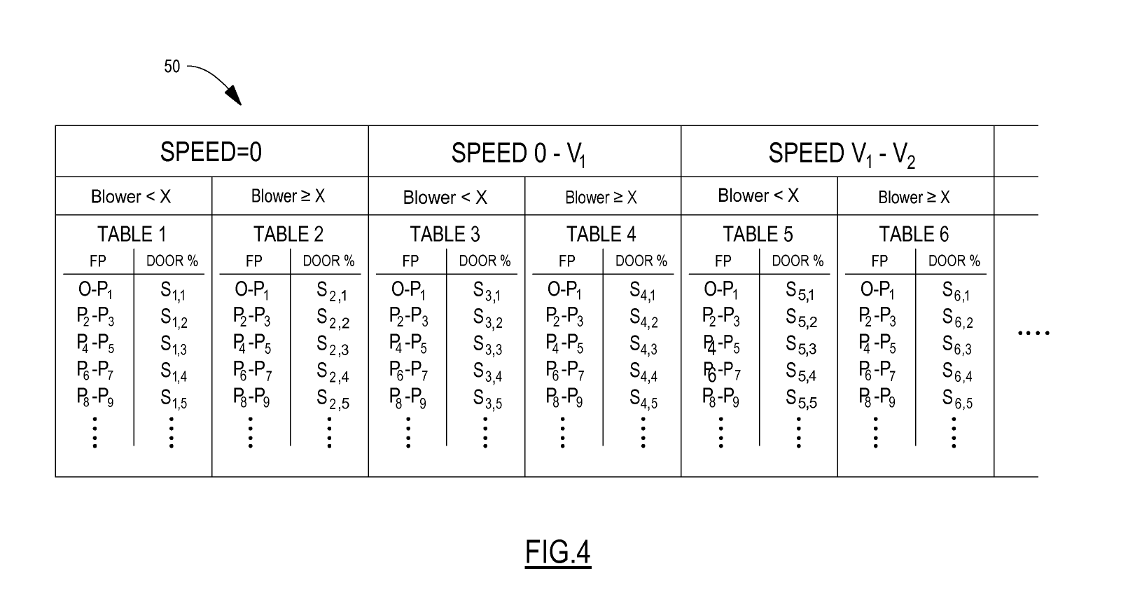

As shown in FIG. 5, the incremental value may be determined in response to values stored in various increment tables 51. The size of the incremental value may depend on the current fogging probability as well as vehicle speed and blower speed. Thus, in a table A, blower speed is less than a predetermined setting X and vehicle speed is less than a vehicle threshold V₁. For a first fogging probability range from zero to P₁, the increment has a calibrated value I₁, and in a second fogging probability range P₂ through P₃, the calibrated value for the increment has a value I₂. For some particular conditions, especially with a high fogging probability, the increment may be set to zero. For higher blower speeds and higher vehicle speeds or combinations thereof, the increment for adding to the base partial recirculation setting may have other calibrated values I₃ through I₁₃. Although not shown, the values for selecting fogging probability ranges preferably include hysteresis values so that once one particular probability range is selected, the bounding values change so that the controller does not oscillate between adjacent table values.

What is claimed is:

1. A method of controlling recirculation of a vehicular HVAC system, comprising the steps of:
detecting an automatic recirculation condition in response to first conditions including a window defrost setting;
determining a fogging probability in response to second conditions including a humidity measurement;
detecting occupancy of a passenger seat adjacent a cabin air return vent; and
setting a partial recirculation of the return vent in response to the fogging probability and the detected occupancy.

2. The method of claim 1 wherein the HVAC system has a variable-speed blower and wherein the step of setting the partial recirculation is comprised of:
obtaining a base setting from a base lookup table according to a vehicle speed and a blower speed, wherein the base lookup table is configured according to a calibration procedure based on the passenger seat being occupied; and
adding an increment to the base setting when the passenger seat is unoccupied.

3. The method of claim 2 wherein the increment is obtained from an increment lookup table according to the vehicle speed and the blower speed.

4. The method of claim 1 wherein the first conditions include at least one of an outside air temperature, engine coolant temperature, windshield wiper setting, vehicle speed, or transmission setting.

5. The method of claim 1 wherein the window defrost setting includes a heated window setting.

6. The method of claim 1 wherein the second conditions further include outside air temperature and in-cabin temperature.

7. Apparatus for a transportation vehicle comprising:
an HVAC system for treating air supplied to a vehicle cabin from an HVAC blower, wherein the HVAC system includes a fresh air inlet, a cabin air return vent, and a recirculation door for selecting a partial recirculation setting that controls an amount of air inlet to the HVAC system via the cabin air return vent, and wherein the HVAC system has a window defrost setting;
a plurality of sensors for obtaining a humidity measurement and detecting whether a passenger seat adjacent to the cabin air return vent is occupied; and
a controller detecting an automatic recirculation condition in response to first conditions including a window defrost setting, determining a fogging probability in response to second conditions including the humidity measurement, and setting a partial recirculation of the cabin air return vent in response to the fogging probability and the detected occupancy.

8. The apparatus of claim 7 wherein the HVAC system comprises a variable-speed blower, wherein the controlled comprises a base lookup table for obtaining a base setting according to a vehicle speed and a blower speed, wherein the base lookup table is configured according to a calibration procedure based on the passenger seat being occupied, and wherein the controller adds an increment to the base setting when the passenger seat is unoccupied.

9. The apparatus of claim 8 further comprising an increment lookup table for providing the increment according to the vehicle speed and the blower speed.

10. The apparatus of claim 7 wherein the sensors further provide an outside air temperature, engine coolant temperature, windshield wiper setting, vehicle speed, or transmission setting, and wherein the first conditions include at least one of the outside air temperature, engine coolant temperature, windshield wiper setting, vehicle speed, or transmission setting.

11. The apparatus of claim 7 wherein the window defrost setting includes a heated window setting.

12. The apparatus of claim 7 wherein the sensors further provide an outside air temperature and an in-cabin temperature, and wherein the second conditions further include the outside air temperature and the in-cabin temperature.
